(19) United States
(12) Patent Application Publication
(10) Pub. No.: US 2026/0358225 A1
(43) Pub. Date: Nov. 12, 2026

(54) DUAL-MODE COUNTER OF ATMOSPHERIC CLOUD CONDENSATION NUCLEI AND CONDENSATION NUCLEI

(71) Applicant: ARIZONA BOARD OF REGENTS ON BEHALF OF THE UNIVERSITY OF ARIZONA, Tucson, AZ (US)

(72) Inventor: Donald R. Huffman, Tucson, AZ (US)

(21) Appl. No.: 19/124,983

(22) PCT Filed: Nov. 3, 2023
(86) PCT No.: PCT/US2023/078602

§ 371 Date: Apr. 28, 2025

Related U.S. Application Data
(60) Provisional application No. 63/422,192, filed on Nov. 3, 2022.

(51) Int. Cl. G01N 15/06; G01N 15/00; G01N 15/02

(52) U.S. Cl. CPC G01N 15/065; G01N 15/02; G01N 2015/0026; G01N 2015/0294

(57) ABSTRACT

A dual-mode apparatus configured to operate in each of the cloud-condensation-nuclei-counting regime and the condensation-nuclei-counting regime and methodology for measuring condensation nuclei with such apparatus. In a specific case, the counting procedure is effectuated with the use of simultaneous acquisition of optical images of nuclei contained in the chamber of the apparatus, which is devoid of use of registration of laser-light scattering.

### CROSS-REFERENCE TO RELATED APPLICATIONS

This International Patent Application claims priority from and benefit of the US Provisional Patent Application No. 63/422,192 filed on Nov. 3, 2022, the disclosure of which is incorporated by reference herein.

### TECHNICAL FIELD

This invention relates to a system configured operate, interchangeably, in either of the cloud-condensation-nuclei-counting regime and the condensation-nuclei-counting regime and methodology for measuring condensation nuclei with such system.

### RELATED ART

The condensation nuclei (CN) are tiny aerosol particles (which may generally range in size from about 1 Angstrom up to about 1 mm) suspended in any gas, including ambient air or atmosphere within the built environment (inside buildings) or in the outdoor, natural environment. CN are so-named as an operational definition, because techniques to detect or measure them utilize the condensation of water or some other condensable fluid to grow the CN into particles or droplets large enough to more efficiently detect. CN are synonymous with aerosol particles or other terms that comprise a class of any combination of liquid, solid, or gel-like materials at sizes small enough for them to stay suspended in air for more than a few seconds.

Some but not all condensation nuclei may provide surfaces in the atmosphere onto which water vapor may condense or otherwise deposit to form a water droplet or an ice particle. As one environmentally relevant effect, CN can serve as the basic building blocks of clouds (not all clouds create precipitation, as rain droplets are much larger than cloud droplets; the temperature and the humidity of the atmosphere dictate whether these water droplets stay as a cloud or fall to the ground as rain, sleet, graupel, or snow, or another hydrometeor).

The condensation nuclei that serve as cloud seeds, on which water vapor condenses, are referred to as cloud condensation nuclei (CCN)—these are atmospheric particles that can absorb or adsorb water in the presence of supersaturated water vapor and which can grow, or activate, to form cloud droplets. The CCN can have the size of about 0.1 to 1 micron or so, or from approximately 1/10 to 1/1000 the diameter of a cloud droplet. For example, if a cloud condensation nucleus is about 0.2 micrometer in size, then a typical cloud droplet would be about 20 micrometers, and a typical raindrop would be 2000 micrometers.

Understandably, counters of CN that are not the CCN counters and those counters that are counters of CCN are generally structured and exploited differently and separably from one another, considering different thermodynamics involved.

The CCN counter is conventionally structured to measure the concentration of aerosol particles by drawing an air sample into a constant volume column/chamber, where a thermodynamically unstable, supersaturated water vapor condition is created by taking advantage of the difference in diffusion rates between water vapor and heat. An example of a typical CCN counter and its operation is provided at www. arm. gov. Information concerning the only CCN counter that is currently commercially available can be found www.tandfonline.com/doi/full/10.1080/02786820500543290 (published as “Mapping the Operation of the DMT Continuous Flow CCN Counter” by S, Lance et al. ; the disclosure of which is incorporated herein by reference). Such thermodynamically unstable supersaturated water vapor condenses onto aerosol particles due to the gradient of temperature created across the chamber: seeking equilibrium, the supersaturated water vapor condenses on the cloud condensation nuclei in the sample air to form droplets, just as cloud drops form in the atmosphere. The activated droplets of water surrounding the CCN that are activated, i.e., grown larger in the process, are counted and sized by an optical particle counter (OPC), which is conventionally structured to employ light-scattering (for example, laser light scattering) approach. In this way, the CCN counter effectively measures activated ambient aerosol particle number concentration as a function of supersaturation. (The supersaturations, i.e. above 100% relative humidity, produced in the condensation chambers of these devices can normally be set within a range from a few tenths of one percent to several percent. However, clouds or haze can begin to form on very hygroscopic particles at saturation levels well below 100%.)

While the counter of CCN is a device that measures the number concentration of atmospheric particles upon which water vapor can condense not only at relatively higher values of supersaturation bur also at relatively low values of supersaturation that are equivalent to those that occur with the formation of tropospheric liquid clouds, a CN counter is a device that is capable of measuring the number concentration of particles upon which a vapor (typically water vapor) requires a higher supersaturation to induce activation and condensation, relative to equilibrium vapor pressure over the liquid phase of the substance. The operation of a conventional CN counter (also commonly referred to as condensation particle counters, CPCs) is associated with a modulation of the temperature (or alternatively pressure, and/or volume) in the chamber or different regions of the counter (implemented optionally by varying a volume of the chamber) or through selective use of sequential regions of differing temperature and/or vapor supersaturation, to which the combination of a vapor of liquid (for example, water vapor) and the target aerosol particles is delivered.

The differences in principles of operation of the CN counters and the CCN counters lead to industrial status quo, according to which a CN counter and a CCN counter are necessarily, without an exception to the best of knowledge of the inventor, different instruments (let alone instruments of sizes and/or weights that substantially prevent the simultaneous exploitation of multiplicity of such instruments).

The problem of operational complexity of conventional approaches to counting the CN and to counting the CCN, employed in related art, is solved by devising a compact apparatus judiciously structured to effectuate both the process of counting of the CN and the process of counting of the CCN—in any order, sequentially, and at the user's discretion—even without the change of employed hardware. Accordingly, an embodiment of the apparatus of the invention may be referred to as a dual measurement system.

The idea of the invention stems at least in part from the realization that the same chamber containing a suspension of particles (such as liquid, solid particles, semi-solid particle, molecular clusters, etc) and water vapor (more generally—a vapor of liquid) may be operated at a constant volume with a temperature gradient formed across it (thereby providing conditions for formation and registering the CCN) and at a volume that is reversibly varied (thereby providing conditions for formation and registering the CN that are not CCN). Moreover, according to the idea of the invention, variation of the pressure at which contents of the chamber are maintained (or volume of the chamber ballast) by different amounts during the CN-counting procedure may facilitate the registration of CN that have different sizes. Herein, the term “size” is used as a general term to denote a characteristic of target particles including at least one of a geometrical size (assessed according to a chosen measure known in related art—such as, for example, an average size, a mean size, or a size distribution across the population of the target particles, aerodynamical size, volume equivalent size, etc), a chemical surface property, and a shape.

Notably, in a specific case the implementation of a portion of the apparatus configured as an optical particle counter does not have to employ conventional light-scattering methodology but, instead, may derive the particle count from optical images of the target particles formed with the use of an imaging detector such as an optical camera. The use of the optical camera as a detector instead of the conventional employment of the laser light scattering technique provides an operational advantage in that one can record the whole process simultaneously in two dimensions. As a result, for example, during the operation of an embodiment of the apparatus in a CCN-counting regime, rate of fall or acceleration of the liquid droplets into a portion of the chamber maintained at a lower temperature can be de-convolved to obtain the size and/or material density of the activated droplets, if required.

### SUMMARY OF THE INVENTION

Embodiments of the invention provide a method carried out in a volume that is enclosed at least in part by a shell housing (the housing containing two opposing walls and an optically-transparent area of the shell, and the volume containing a suspension of particles and vapor of liquid in a gas). Such method includes identifying first particles by exposing the first particles to a temperature gradient throughout the volume from a first wall of the two opposing walls to a second wall of the two opposing walls thereby causing condensation of the vapor of liquid on said first particles and optically counting these first particles (whether with the use of light-scattering methods and/or detector-based imaging, for example employing an optical camera) through the optically-transparent area of the shell. The method also includes identifying second particles of a first characteristic by substantially abruptly changing a pressure in the volume from a first pressure to a second pressure thereby causing condensation of the vapor of liquid on the second particles of the first characteristic and optically counting such second particles through the optically-transparent area of the shell. (The first characteristic includes at least one of a geometrical size, a chemical surface property, and a shape.) The step of exposing the first particles to a temperature gradient may include changing a temperature of the first wall in comparison with a temperature of the second wall (and, in particular, creating a temperature gradient between a top of the volume and a bottom of the volume) and/or a step of changing a pressure in the volume may include substantially abruptly changing a measure of the volume from a first volume value to a second volume value. Alternatively or in addition—and substantially in every implementation of the method—the thermal conductivity of a material of the optically-transparent area of the shell may be chosen to be different from the thermal conductivity of at least one of the first and second walls and/or the step of substantially abruptly changing a pressure in the volume may include varying a separation between two opposing each other portions of the shell and/or fluidly connecting an auxiliary volume to the volume. (In the specific version of the latter case, varying the separation may include repositioning a piston and/or the step of fluidly connecting the auxiliary volume may include moving a shutter fluidly separating the auxiliary volume from the volume.) Alternatively or in addition, and substantially in every implementation of the method, the step of substantially abruptly changing a pressure in the volume may be configured as increasing a size of the volume such that the second measure is larger than the first measure and/or the step of identifying the second particles of the first characteristic may be configured to include maintaining a first temperature of the first wall and a second temperature of the second wall. Optionally, every implementation of the method may include a process of substantially evening out temperature throughout the volume and/or a situation when at least one of the optically-counting the first particles and optically-counting the second particles of the first characteristic includes substantially simultaneously forming optical images of such particles, illuminated with an external light, with an optical detector through the optically-transparent area of the shell. Optionally, a given embodiment may additionally include delivering the vapor of the liquid and/or the liquid to the volume (where, in a specific case, such delivering may include wetting a hydrophilic material disposed within the volume and/or passing the vapor and/or liquid through a material mesh). Alternatively or in addition, substantially every implementation of the method may contain a step of identifying second particles of a second characteristic by substantially abruptly changing the pressure in the volume from the second value to a third value or from the first value to the third value thereby causing condensation of the vapor of liquid on the second particles of the second characteristic (here, the second characteristic includes at least one of a geometrical size, a chemical surface property, and a shape) and optically counting such second particles of the second characteristic through the optically-transparent area of the shell. (Optionally, in this case, the step of the substantially abruptly changing the pressure in the volume may include varying an existing separation between two opposing each other portions of the shell—and, in one case, increasing the size of the volume—and/or fluidly complementing the volume with a supplemental volume. The step of modifying the separation may be configured to include repositioning an auxiliary piston and/or the step of fluidly complementing may include moving a screen fluidly separating the supplementary volume from the volume. The step of optically counting the second particles of the second characteristic may include simultaneously forming optical images of the second particles of the second characteristic, illuminated with the external light, with the optical detector through the optically-transparent area of the shell.) In the process of carrying substantially every embodiment of the method, a wavelength and/or a state of polarization of the external light can be varied prior to effectuating a corresponding step of optical counting. Alternatively or in addition—and substantially in every embodiment—the method may include (i) generating a visually-perceivable representation of a spatial density of identified particles as a function of a chosen characteristic thereof and/or as a function of a wavelength of external light and/or as a function of a state of polarization of external light used to illuminate the particles prior to corresponding optical counting (here, the chosen characteristic may include at least one of the geometrical size, the chemical surface property, and the shape) and/or (ii) counting of cloud condensation nuclei and counting of condensation nuclei that are not cloud condensation nuclei.

Preferably, the counting of cloud compensation nuclei and the counting of condensation nuclei that are not cloud compensation nuclei is performed sequentially with the use of the very same apparatus.

Embodiments additionally provide a computer program product for use on a computer system for determining the presence of and/or counting condensation nuclei of different types in a sample of chosen gas that contains vapor of a liquid with the use of light from a light source. Such computer program product includes a computer usable tangible non-transitory storage medium containing computer readable program code thereon. The computer readable program code includes at least program code for illuminating, with the light, the sample of chosen gas contained within a volume enclosed at least in part by a shell housing (which shell housing includes two opposing walls and an optically-transparent area of the shell) and program code for forming a temperature gradient throughout the volume from the first wall to the second wall to cause condensation of the vapor on first particles contained in the volume. The computer readable program code also includes program code for optically counting said first particles carrying said vapor condensed thereon through the optically-transparent area of the shell and—in at least one specific implementation—may optionally additionally include a) program code for substantially abruptly changing a pressure in the volume (from a first pressure to a second pressure to cause condensation of said vapor on second particles of a first characteristic, where the characteristic includes at least one of a geometrical size, a chemical surface property, and a shape) and/or b) program code for optically counting such second particles carrying the vapor condensed thereon through the optically-transparent area of the shell. (In at least one specific case of the latter, at least one of the program code for optically counting the first particles and the program code for optically counting the second particles of the first characteristic may be configured to include program code for simultaneously acquiring optical images of corresponding particles, formed in said light, with an optical detection system.) Alternatively or in addition, a computer program code may include program code for varying a wavelength of the light and/or for varying a polarization state of the light, and/or program code for defining a dependency of spatial density of particles counted in the sample as a function of a corresponding characteristic thereof and/or as a function of the wavelength and/or as a function of the polarization state (where the corresponding characteristic includes at least one of a geometrical size, a chemical surface property, and a shape). Alternatively, or in addition—and substantially in every implementation—the computer program code may be structure such that as to address the situation where one of the first particles and the second particles are cloud condensation nuclei while the other of the first particles and the second particles are condensation nuclei that are not said cloud condensation nuclei.

Furthermore, embodiments of the invention additionally provide an article of manufacture (which can be configured as an apparatus or system) that includes (i) a cavity defined at least in part by a shell having first and second walls and a shell area that is optically transparent (here, at least one of the first and second walls is configured to form a thermal gradient across the cavity), (ii) a device configured to substantially abruptly change a volume of the cavity, and (iii) an optical detection system cooperated with the shell area to form an image of illuminated contents of the cavity through the shell area. In at least one implementation, the article of manufacture may optionally include a microprocessor and an associated tangible computer readable medium that includes a computer readable program code thereon (which computer readable program code contains a series of computer readable program steps to effect at least illuminating the particles with light generated by a source of light). Generally, the article of manufacture may be structured to satisfy at least one of the following conditions: (a) at least one of the first and second walls is operably connected to a thermoelectric cooler; (b) the optical detection system is configured to simultaneously form optical images of the particles that have been illuminated with the light; and (c) wherein the article further comprises the source of light. Optionally, the computer readable program code may further includes—in at least one specific embodiment—a series of computer readable program steps to effect(i) generating a spatial gradient of temperature throughout a volume of the cavity, and (ii) producing a parameter of first particles of the particles contained in the cavity that have become optically detectable by the optical detection system in said light as a result of said generating (here, the parameter includes at least one of a count, a rate of movement, an acceleration of movement). In at least one specific case generating a spatial gradient of temperature includes generating the spatial gradient between a top of the shell and a bottom of the shell, wherein a temperature at the top of the shell is higher than a temperature at the bottom of the shell. In more than one implementation of the article of manufacture, the computer readable program code may additionally include a series of computer readable program steps to effect (1) activating the device to substantially abruptly change pressure in the volume of the cavity from a first pressure to a second pressure and (2) producing a count of second particles of a first characteristic that have become optically detectable by the optical detection system in the light as a result of such activating (here, the first characteristic includes at least one of a geometrical size, a chemical surface property, and a shape). The step of activating the device may include expanding the volume of the cavity and/or the computer

Readable program code may additionally include a series of computer readable program steps to effect the step of activating while substantially maintaining a first temperature of the first wall and a second temperature of the second wall. Alternatively or in addition, and substantially in every implementation of the article, the computer readable program code may additionally include a series of computer readable program steps to effectuate operating the device to substantially abruptly vary the pressure from the first pressure to a second pressure; and producing a count of second particles of a second characteristic that have become optically detectable by the optical detection system in the light as a result of such operating (here, the second characteristic includes at least one of a geometrical size, a chemical surface property, and a shape). Alternatively or in addition—and substantially in every implementation of the article of manufacture—the computer readable program code may additionally contain a series of computer readable program steps to carry out (i) generating a representation of a spatial density of the particles as a function of a chosen characteristic thereof and/as a function of a wavelength and/or as a function of a state of polarization of the light used to illuminate such particles prior to corresponding producing a count (here, the chosen characteristic includes at least one of a geometrical size, a chemical surface property, and a shape) and/or the device may be configured to includes a repositioner structured to move a portion of the shell. In at least one specific case, the article of manufacture may additionally include means for delivering a vapor of liquid and/or of liquid and/or of particles to the cavity and/or—when the article includes the source of light a combination of the source of light and the optical detection system may be configured to generate and/or to register such light at (a) a variable wavelength (that is, a wavelength subject to variation), and/or (b) a variable polarizations (that is in a polarization state that is subject to variation). Alternatively or in addition, in at least one specific implementation, the article of manufacture may be configured (i) to operate as a counter of condensation nuclei and/or as a counter of cloud condensation nuclei and/or (ii) to not operate as anything else but as a counter of condensation nuclei, a counter of cloud compensation nuclei, or both as a counter of condensation nuclei and as a counter of cloud condensation nuclei. The first wall of the shell may be configured as a top plate of the shell and the second wall may be configured as a bottom of the shell. (Here, when at least one of the top and bottom plates is operably connected to a thermoelectric cooler, the thermoelectric cooler may be configured to maintain the bottom plate at a temperature that is lower than the temperature of the top plate.)

### BRIEF DESCRIPTION OF THE DRAWINGS

For a more complete understanding of the disclosure, reference should be made to the following detailed description and accompanying drawing figures of which:

FIG. 1 illustrates schematically an embodiment of an apparatus structured according to the idea of the invention;

FIG. 2 provides a perspective view of practical implementation of the embodiment schematically illustrated in FIG. 1;

FIG. 3 illustrates the user interface used in operation of the embodiment of the dual mode apparatus of the invention and the corresponding initial output;

FIG. 4 contains plots illustrating experimental and theoretical data that shows critical diameter (D_{crit}) of pure glutaric acid particles at which they induce activation, as a function of supersaturation (above 100% relative humidity). Reproduced from open access publication of Koehler, K. A., et al., Water activity and activation diameters from hygroscopicity data—Part II: Application to organic species. Atmos. Chem. Phys., 2006. 6(3): p. 795-809, the disclosure of which is incorporated herein by reference. Lower supersaturation requires larger particles to activate;

FIG. 5 represents experimental data reproduced from the open access publication by Petters, M. D. and S. M. Kreidenweis (A single parameter representation of hygroscopic growth and cloud condensation nucleus activity, Atmos. Chem. Phys., 2007. 7(8): p. 1961-1971) showing the critical supersaturation (water saturation above 100% relative humidity) required to activate particles composed of pure materials of varying hygroscopicity (κ) and at varying dry particle diameter;

FIG. 6 illustrates relationship between water saturation ratio (left), particle diameter (right), and pressure drop following expansion of the volume, each for two different relative humidity (RH) values. Initial conditions before expansion and corresponding pressure drop are 1013 hPa (atmospheric pressure near sea level) and 298 K. Curves show that the greater the pressure drop (moving to the right) from initial conditions, the diameter that can active (gray curves) drop and the saturation ratio (black) increases. Reproduced from Saghafifar, H., et al., Characterization of a Modified Expansion Condensation Particle Counter for Detection of Nanometer-Sized Particles. Aerosol Science and Technology, 2009. 43(8): p. 767-780.

FIG. 7 presents experimental data showing concurrent dual operation of CN and CCN counting, of an embodiment of the dual-mode apparatus of the invention. Number concentration (cm⁻³) of both CN and CCN are shown on the left axis (black). Total particle concentration measured as CCN+remaining CN. Ratio of the number of particles activated (CCN/Total number) shown on right axis (red). Experiment was performed using laboratory room air for 180 minutes as a proof-of-concept. Top and bottom plates were held at a relative ΔT of ~3.5 °C.

FIG. 8 illustrates another set of experimental data showing concurrent dual operation of CN and CCN counting, of an embodiment of the dual-mode apparatus of the invention. Number concentration (cm⁻³) of both CN and CCN are shown on the left axis (black). Ratio of the number of particles activated (CCN/Total number) shown on right axis (red). Experiment was performed by nebulizing sucrose particles from an ultrapure water solution, drying water from the nebulized droplets, and size-selecting from the polydisperse distribution of particles using a differential mobility analyzer. Pure sucrose particles of ~20 nm diameter (left) and ~350 nm diameter (right) were sequentially sampled by the instrument for approximately 6 minutes each as a proof-of-concept. The relative ratio of activated particles (CCN/Total number) increases from 38% at 20 nm to 71% at 350 nm, which is qualitatively consistent with the expectation that larger particles will activate particles into water droplets more efficiently as particle size increases.

Generally, the sizes and relative scales of elements in Drawings may be set to be different from actual ones to appropriately facilitate simplicity, clarity, and understanding of the Drawings. For the same reason, not all elements present in one Drawing may necessarily be shown in another. While specific embodiments are illustrated in the figures with the understanding that the disclosure is intended to be illustrative, these specific embodiments are not intended to limit the scope of invention implementations of which are described and illustrated herein.

### DETAILED DESCRIPTION

In one non-limiting embodiment, the chamber of the apparatus of the invention may be configured as a chamber with a volume that is limited by a shell two opposite walls of which are operationally configured to be maintained (reversibly and/or changeably and/or optionally, when required) at different temperatures—thereby providing a situation when a gradient of temperature may be created across the chamber volume between such two opposite walls for CCN counting.

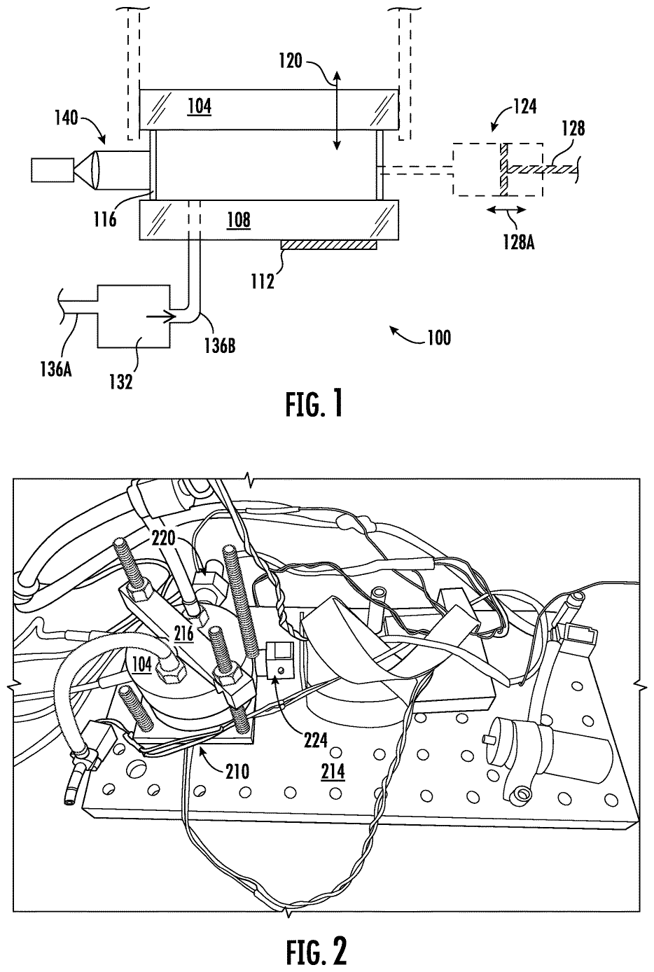

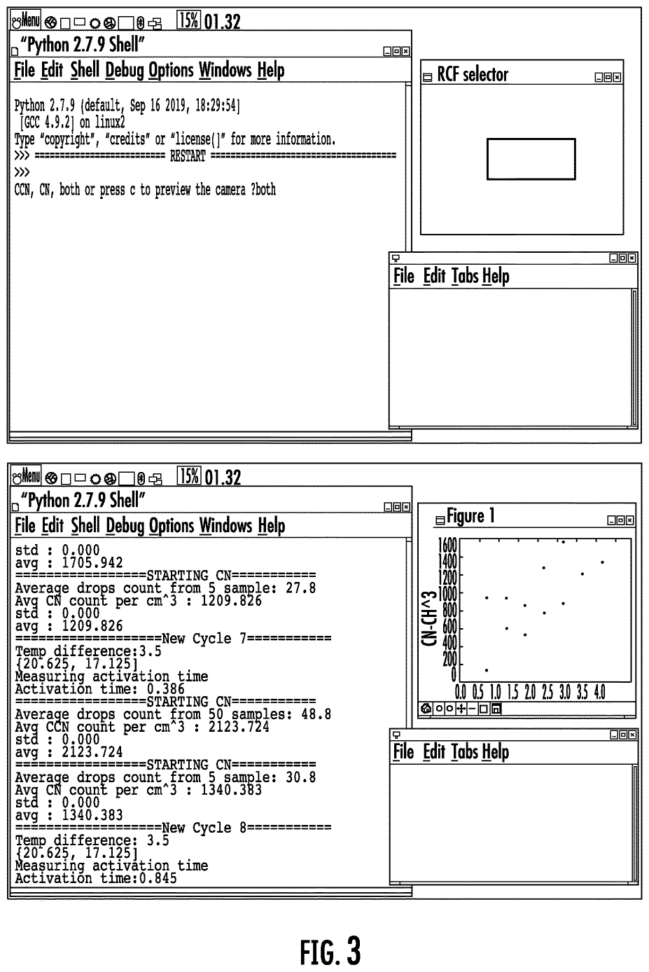

In reference to a schematic of FIG. 1, illustrating a specific embodiment 100 of the apparatus of the invention, the volume of the chamber is shown to be limited on two sides by top and bottom walls 104, 108 (top and bottom, for simplicity, one or both of which may be structured as plates of material having operationally substantially high thermal conductivity, and with at least one of which—for example, the bottom—a corresponding thermo-electric cooler device 112 may be juxtaposed). The top and bottom may include aluminum, for example. The volume of the chamber may also be limited with side wall(s) at least a portion of which is made optically transparent. Side wall(s) may be formed at least in part by, for example, a quasi-cylindrical wall 116, as shown (defining the main part of the chamber) that is made at least in part of a glass-like or more generally optically-transparent material.

To effectuate a change of pressure in the volume (for example, expansion, optionally reversible) of the chamber, which provides for conditions needed for CN counting, in at least one implementation at least one of the top and bottoms 104, 108 may be configured to be movable along an axis of the quasi-cylindrical wall of the shell (akin to the movement of the piston; indicated schematically with an arrow 120) and/or such pressure change may be effectuated in a complementary portion of the chamber 124 extending from the main part of the chamber and complemented with a moveable piston (as shown, 128 and arrow 128A) or a moveable screen/shutter creating a separation between two volume portions.

As a skilled person will readily appreciate, in order to count the number of particles, such particles must first be coated with liquid (water, for example) to increase the size of the so-formed aerosol element as compared to that of the initial particle. According to the idea of the invention, two different ways to do this may be employed. The first way is to introduce extra liquid and/or liquid vapor into the chamber before closing it for measurements by wetting hydrophilic or porous material (for example, at least one piece of chemical filter paper; not shown in FIG. 1 for simplicity of illustration) with such liquid and affixing material to the top and/or bottom inner surfaces of the chamber to provide increased humidity in the chamber. A second way me be to use an external humidifier 132, which may contain a closed chamber at least partially filled with liquid and/or liquid vapor and having import and exit ports 136A, 136B that lead the liquid and/or aerosol into the chamber of the apparatus chamber. Such humidifier chamber may also contain a pliable wicking material, partly immersed in liquid through which the incoming aerosol passes to take up liquid before entering the chamber. Notably, the process of humidification of the contents of the chamber may be implemented by drawing or pushing air (or another gas) that includes target particles subject to measurement.

The optical detection system 140, optically connected with the volume of the chamber of the apparatus through the optically-transparent portion of the side wall 116, may be structured conventionally to employ the registration of laser light scattering at the particles within the volume or, preferably and according to the idea of the invention—with the use of an optical camera configured to effectuate the coupling of the target particle based on optical images of such particles that are taken simultaneously for all particles (by, for example, optically imaging the contents of the chamber onto the optical detector of the system 140).

In addition to the walls/shell of the chamber having at least a portion made of optically transparent material, it may be advantageous to make such shell of optically-opaque material with multiple (in one case—two) optically-transparent windows, one for illumination of contents of the chamber and another for optical detection. The use of such specific version of the chamber diminishes the problem of unwanted spurious reflections of light inside the chamber which compromise the integrity of the true, sought-after signals.

Several versions of the apparatus have been fabricated, with different physical parameters and attributes. FIG. 2 shows, in a perspective view, one specific implementation of the embodiment schematically illustrated in FIG. 1. As shown, the closed chamber of the apparatus was constructed with the use of two circular aluminum plates with thickness of about ¼ inch and an approximately 2½ inch diameter as first and second walls (configured, in reference to FIG. 1, as top and bottom plates 104, 108). The optically-transparent area of the shell was configured as a glass cylinder 116 (with about ⅛ inch thick wall and about ⅜ inch in height). The volume enclosed by the plates 104, 108 and the cylindrical wall 116 between the two plates and interior to the cylindrical area forms the cavity in which particles subject to identification and detection are activated and fall. A rubber O-ring or gasket was used to seal the glass cylinder to each of the top and bottom plates 104, 108. A thermoelectric cooler was attached underneath the bottom plate to lower the temperature of the bottom in order to produce a temperature differential with respect to the top plate (which, in turn, was preferably simply left at room temperature). The combination of the top and bottom plates, the glass cylinder, and the thermoelectric cooler was placed on a square aluminum stage 210 of ⅜ inch thickness, and mounted to the floor of the instrument (in one incarnation—a 6 inch×12 inch optical breadboard 214) using ¼ inch bolts such that the stack was suspended by about 1 inch above the floor level. A 1½ inch square computer fan was attached to the bottom of the aluminum stage 210 to provide cooling agent to the hot side of the thermoelectric cooler. As seen in the example of FIG. 2, an aluminum bar 216 was mounted over the top plate 104 to be pulled downward and secured with ¼ inch bolts to squeeze the O-ring in between the top and bottom plates of the construct. (Alternatively, the use of set-screws and/or clamping may be employed to seal the cavity to ensure lack of air leaks.) Thermocouple probes were inserted into holes drilled horizontally in the bottom plate 108 (below the cavity) and into the metal retaining bar 216 holding the top plate 104 in place.

A red diode laser 220 (configured to operate at 650 nm wavelength) was attached on a mount such as to direct the output beam through the glass cylindrical wall 116 approximately the center of the cavity. A Rasperry Pi camera 224 with lens was attached on a separate mount, pointing towards the center of the cavity along the axis inclined, with respect to the output beam from the laser source 220, at an angle of about 90 degrees, to optically image and/or record the particles and/or droplets that fall within the cavity. One tube (of ¼ inch outer diameter) was fluidly coupled with a barbed fitting attached to a hole drilled through the top plate 104 such as to pass through a stop valve (valve #1) and then into the room air or the volume of particles in the gas to be sampled. A second tube (of ¼ inch outer diameter) was fluidly coupled with a second barbed fitting attached to a hole drilled through the top plate 104 such as to connect to a valve and optionally to a separate ballast volume, and then to the air pump.

In one incarnation of the instrument, a porous quarter fiber piece of filter paper was spatially cooperated with the bottom (internal to the cavity) surface of the top plate 104 while another filter paper was placed to rest on the bottom plate 108. These pieces were wetted to provide a source of water vapor within the cavity. In one incarnation of the instrument, liquid water was channeled to the filter paper using a hole formed through the top plate, with water delivered by peristaltic pump. In a related embodiment, water was channeled to the filter paper using a woven wick, with one end of the wick submerged in liquid water. In yet another related embodiment, water vapor was transported into the chamber as input air was passed over a liquid water reservoir.

The laser, the optical camera, the air pump, and the air valves were connected via electrical wiring to a custom made “hat” (electrical interface) at the top of the Raspberry Pi board, operably cooperated with a judiciously structured electronic circuitry (that included a programmable processor) to provide power, control, and data output and processing. A computer program product used to operate an embodiment of the instrument (and, in particular, to govern the operation of the cycle pump, to acquire images from the camera, and to turn on/off valves and to acquire experimental data) was written in Python and operated from the Raspberry Pi computer. The user interface and initial output are illustrated in FIG. 3.

The skilled artisan will readily appreciate that a thermodynamical basis for understanding the relationship between particles (condensation nuclei, CN) and the point at which they can adsorb water and grow into droplets (aka “activation”) is provided by Köhler theory (see, for example, Petters, M.D. et al., A single parameter representation of hygroscopic growth and cloud condensation nucleus activity, in Atmos. Chem. Phys., 2007. 7(8): p. 1961-1971; and/or Köhler, H., The nucleus in and the growth of hygroscopic droplets, in Transactions of the Faraday Society, 1936. 32: p. 1152-1161, the disclosure of each of which is incorporated herein by reference).

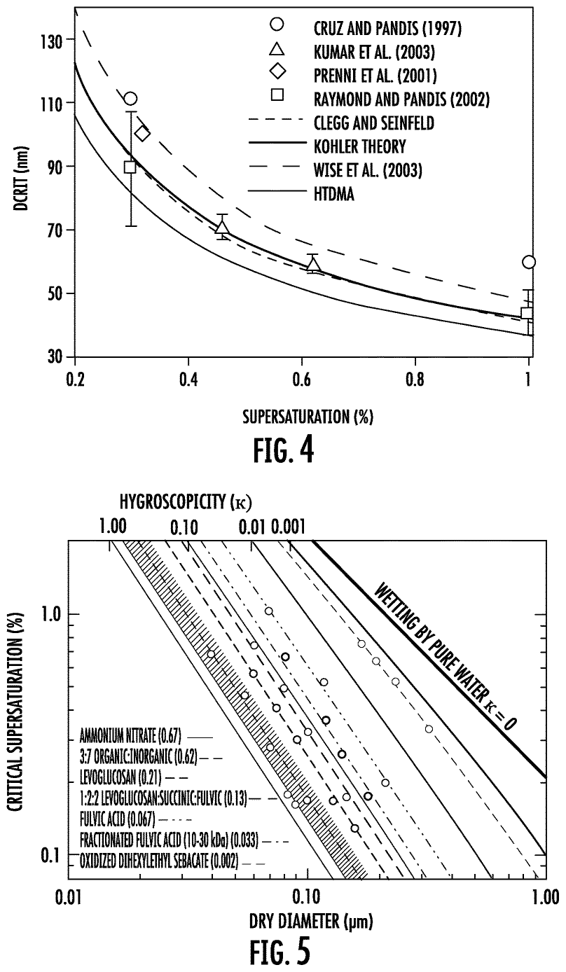

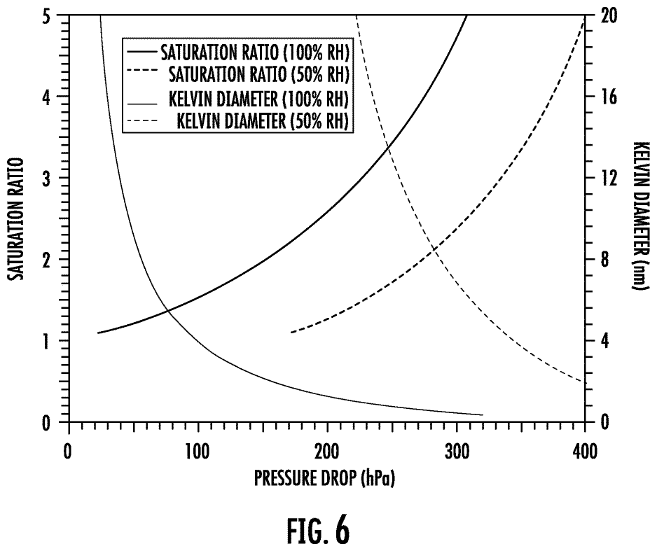

This long-standing theory is central for explanation of processes by which targeted particles activate to form cloud droplets in the atmosphere and by which particles are grown to more easily detectable sizes within commercially available instruments, e.g. condensation nucleus counters (CN counters) and cloud condensation nucleus counters (CCN counters). As recognized in related art, one important practical outcome of the theory is that particles of decreasing size require a correspondingly greater supersaturation to induce activation (FIG. 4). The second practical outcome is that particles of greater hygroscopicity (i.e. greater affinity for water adsorption; e.g. particles dominated by polar ionic salts) begin to activate (i.e. to form droplets) at smaller original particle size than for particles of lower hygroscopicity (e.g., comprised of non-polar organic materials) (FIG. 5). When Köhler theory is applied to utilize quasi-adiabatic volume expansion to induce supersaturation for activation of all particles (i.e., as in the case of the CN counter operation), the third outcome is that the conditions require an increasingly larger pressure drop from initial conditions to induce activation as the particle size decreases (for constant material composition). A corollary to this point is that the supersaturation that can be achieved for a given particle size and composition increases as the magnitude of the pressure drop increases. These conclusions are highlighted in FIG. 6. Quantitative relationships can be derived from first principles of Köhler theory, and have also been the subject of much experimental work.

The above information thus lays the foundation for which an embodiment of the dual-mode CN-CCN instrument operates. As the skilled artisan will now appreciate, when operated in CCN mode, a relatively lower supersaturation is achieved through inducing a temperature differential across the chamber volume. This process activates a sub-set of the particles in a given ensemble. For a given particle composition, the CCN fraction will preferentially be comprised particles larger than a given critical size cut-point. Or for particles at a given diameter, particles of higher hygroscopicity will preferentially be activated. When operated in CN mode, a relatively higher supersaturation is achieved through inducing a quasi-adiabatic volume expansion to abruptly reduce chamber pressure (usually from a starting point at room atmospheric pressure). Using Köhler theory, it is understood that a greater supersaturation immediately develops, and so particles of much smaller diameter and/or of much lower hygroscopicity can be activated. By this method, particles of a few nanometers or lower may be activated and subsequently detected (see, for example, Kürten, A., et al., Characterization of an Automated, Water-Based Expansion Condensation Nucleus Counter for Ultrafine Particles. Aerosol Science and Technology, 2005. 39(12): p. 1174-1183).

When operated sequentially in CCN mode and then in CN mode, CCN are first activated, fall, and are detected. Accordingly, as a skilled person will understand and reproduce without need in excessive experimentation, a method for measuring condensation nuclei is effectuated, which method is performed in a volume enclosed at least in part by a shell housing (that includes two opposing walls and an optically-transparent area of the shell, where the volume contains a suspension of particles and vapor of liquid in a gas). An embodiment of the method includes identifying first particles by exposing the first particles to a temperature gradient throughout the volume from a first wall of the two opposing walls to a second wall of the two opposing walls thereby causing condensation of the vapor of liquid on the first particles; optically counting such first particles through the optically-transparent area of the shell; identifying second particles of a first characteristic by substantially abruptly changing a pressure in the volume from a first pressure to a second pressure thereby causing condensation of the vapor of liquid on the second particles of the first characteristic; and optically counting the second particles of the first characteristic through the optically-transparent area of the shell. Optionally, the step of exposing the first particles to a temperature gradient includes changing a temperature of the first wall in comparison with a temperature of the second wall; and/or the step of changing a pressure in the volume includes substantially abruptly changing a measure of the volume from a first volume value to a second volume value. In addition to the above characteristics of an embodiment of the method, the step of exposing the first particles to a temperature gradient may include creating a temperature gradient between a top of the volume and a bottom of the volume in at least one case. Further, at least in one specific implementation, the step of substantially abruptly changing a pressure in the volume is realized by varying a separation between two opposing each other portions of the shell and/or fluidly connecting an auxiliary volume to the volume. In particular, the step of varying the separation may employ the repositioning of a piston and/or the step of fluidly connecting the auxiliary volume may include moving a shutter fluidly separating the auxiliary volume from the volume. Alternatively or in addition, the step of substantially abruptly changing a pressure in the volume may be realized by increasing a size of the volume such that the second measure is larger than the first measure.

Using one prototype of the instrument, the cavity volume is expanded by opening a valve connected to an evacuated tube or other ballast volume, thus inducing higher supersaturation, and so particles that remain after CCN were removed then activate as CN, fall, and are detected. In this way, if the CCN comprise a small subset of the total ensemble of available particles, the first mode exhibits relatively fewer falling droplets, and when the second (CN) mode is initiated, a greater number of falling droplets are observed.

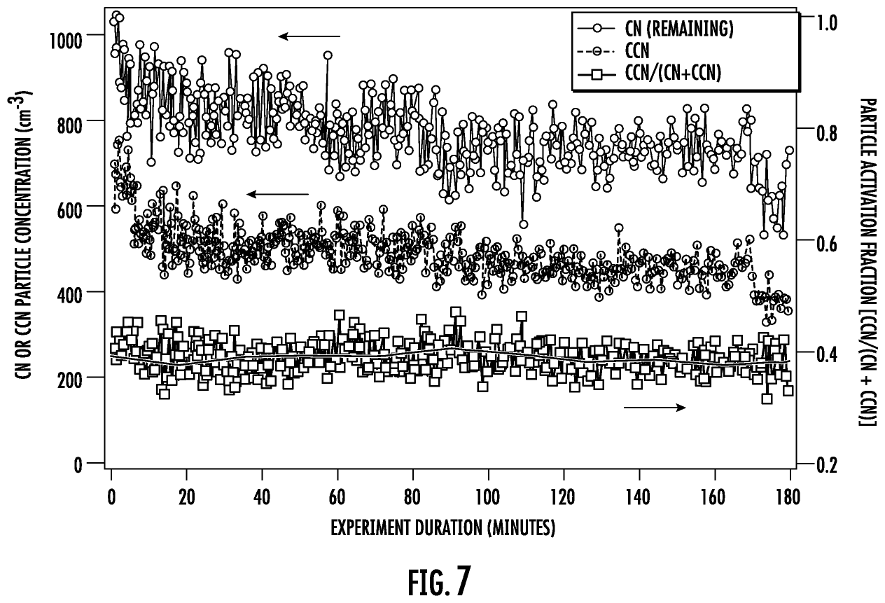

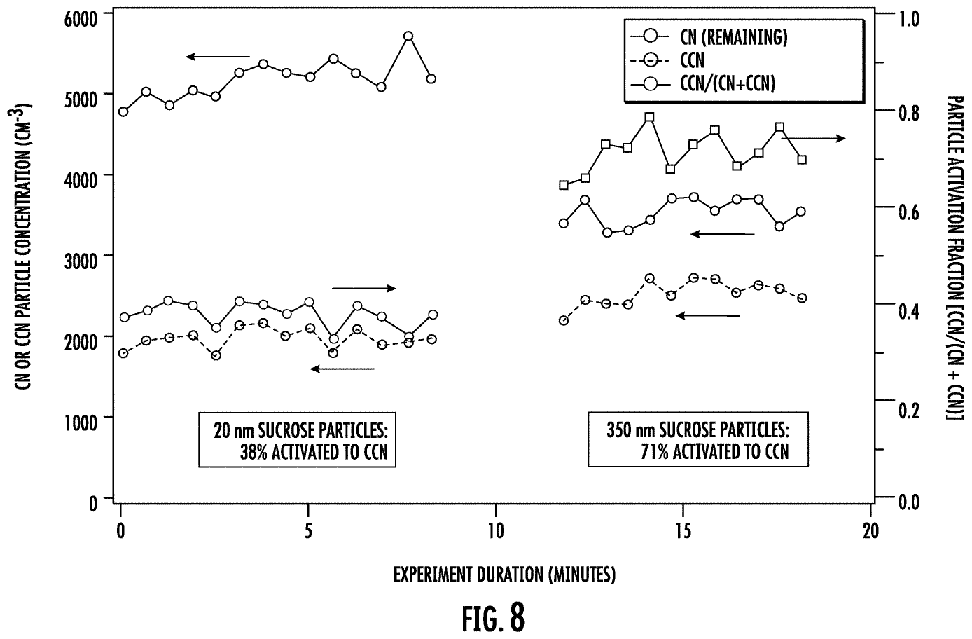

Experimental data obtained with the use of one specific embodiment of the prototype of the dual-mode CN-CCN instrument structured according to the idea of the invention are shown in FIGS. 7 and 8.

FIG. 7 presents experimental results following concurrent dual operation of CN and CCN counting modes. The purpose of this plot is to demonstrate proof-of-concept for ambient measurement of both CN and CCN. During this three-hour window, the concentration and population of ambient particles was relatively consistent, and the activation ratio shows that approximately 40% of the CN activated as CCN. This experiment highlights the ability of the instrument to measure both CN and CCN in the same chamber (or instrument) without additional uncertainties introduced by using different instruments to measure the two values. FIG. 8 shows experimental data for both CN and CCN counting following the generation of pure, dry sucrose particles (as a material of intermediate hygroscopicity). Qualitatively consistent with Köhler theory, the smaller particles (20 nm) activate less efficiently than the larger particles (350 nm) for a given volume expansion and temperature differential.

Additional considerations of the proposed dual-mode methodology includes the following:—The working liquid may be water or another condensable fluid, with an advantage of exploring chemical properties of various aerosols with chemicals other than water;—The chamber of the apparatus, in addition to its ability to permit activating the particles may be used also to detect inherently large particles (e.g. dust or pollen grains) that are sized enough to be detected without activation with additional liquid;—The ability to explore different supersaturation levels may be additionally performed with the use of the computer-controlled apparatus by adding several ballast external volumes (auxiliary chambers of different volumes), each with its communicating valve enabling numerically different expansions of the main chamber volume during the CN measurement process. The disclosure of each patent document or other document referred to in this application is incorporated herein by reference.

References throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of the phrases “in one embodiment,” “in an embodiment,” and similar language throughout this specification may, but do not necessarily, all refer to the same embodiment. It is to be understood that no portion of disclosure, taken on its own and in possible connection with a figure, is intended to provide a complete description of all features of the invention.

For the purposes of this disclosure and the appended claims, the use of the terms “substantially”, “approximately”, “about” and similar terms in reference to a descriptor of a value, element, property or characteristic at hand is intended to emphasize that the value, element, property, or characteristic referred to, while not necessarily being exactly as stated, would nevertheless be considered, for practical purposes, as stated by a person of skill in the art. These terms, as applied to a specified characteristic or quality descriptor means “mostly”, “mainly”, “considerably”, “by and large”, “essentially”, “to great or significant extent”, “largely but not necessarily wholly the same” such as to reasonably denote language of approximation and describe the specified characteristic or descriptor so that its scope would be understood by a person of ordinary skill in the art. In one specific case, the terms “approximately”, “substantially”, and “about”, when used in reference to a numerical value, represent a range of plus or minus 20% with respect to the specified value, more preferably plus or minus 10%, even more preferably plus or minus 5%, most preferably plus or minus 2% with respect to the specified value. As a non-limiting example, two values being “substantially equal” to one another implies that the difference between the two values may be within the range of +/−20% of the value itself, preferably within the +/−10% range of the value itself, more preferably within the range of +/−5% of the value itself, and even more preferably within the range of +/−2% or less of the value itself. The use of these terms in describing a chosen characteristic or concept neither implies nor provides any basis for indefiniteness and for adding a numerical limitation to the specified characteristic or descriptor. As understood by a skilled artisan, the practical deviation of the exact value or characteristic of such value, element, or property from that stated falls and may vary within a numerical range defined by an experimental measurement error that is typical when using a measurement method accepted in the art for such purposes.

The use of these terms in describing a chosen characteristic or concept neither implies nor provides any basis for indefiniteness and for adding a numerical limitation to the specified characteristic or descriptor. As understood by a skilled artisan, the practical deviation of the exact value or characteristic of such value, element, or property from that stated falls and may vary within a numerical range defined by an experimental measurement error that is typical when using a measurement method accepted in the art for such purposes.

The term “A and/or B” or a similar term means “A alone, B alone, or A and B together” and is defined to be interchangeable with the term “at least one of A and B.”

While the invention is described through the above-described exemplary embodiments, it will be understood by those of ordinary skill in the art that modifications to, and variations of, the illustrated embodiments may be made without departing from the inventive concepts disclosed herein. Disclosed aspects, or portions of these aspects, may be combined in ways not listed above. Accordingly, the invention should not be viewed as being limited to the disclosed embodiment(s).

1.-82. (canceled)

83. An article of manufacture, comprising:
a cavity defined at least in part by a shell having first and second walls and a shell area that is optically transparent,
wherein at least one of the first and second walls is configured to form a thermal gradient across the cavity;
a device configured to substantially abruptly change a volume of said cavity; and
an optical detection system cooperated with said shell area to form an image of illuminated contents of the cavity through the shell area.

84. An article of manufacture according to claim 83, wherein said device includes a repositioner configured to move a portion of said shell and/or wherein said article comprises means of delivery of a vapor of liquid and/or of liquid and/or of particles to said cavity.

85. An article of manufacture according to claim 83, further comprising
a microprocessor and a tangible non-transitory computer readable medium comprising computer readable program code thereon, the computer readable program code comprising a series of computer readable program steps to effect:
illuminating the particles with light generated by a source of light,
wherein the at least one of the first and second walls is operably connected to a thermoelectric cooler and/or wherein said optical detection system is configured to simultaneously form optical images of the particles that have been illuminated with the light and/or wherein the article further comprises the source of light.

86. An article of manufacture according to claim 85, wherein said computer readable program code further comprises a series of computer readable program steps to effect:
generating a spatial gradient of temperature throughout a volume of the cavity, and
producing a parameter of first particles of the particles contained in the cavity that have become optically detectable by the optical detection system in said light as a result of said generating, wherein the parameter includes at least one of a count, a rate of movement, an acceleration of movement.

87. An article of manufacture according to claim 86, wherein said generating a spatial gradient of temperature includes generating the spatial gradient between a top of the shell and a bottom of the shell, wherein a temperature at the top of the shell is higher than a temperature at the bottom of the shell.

88. An article of manufacture according to claim 85, wherein said computer readable program code further comprises a series of computer readable program steps to effect:
activating the device to substantially abruptly change pressure in the volume of said cavity from a first pressure to a second pressure; and
producing a count of second particles of a first characteristic that have become optically detectable by the optical detection system in the light as a result of said activating,
wherein the first characteristic includes at least one of a geometrical size, a chemical surface property, and a shape.

89. An article of manufacture according to claim 88, wherein said activating the device includes expanding the volume of said cavity.

90. An article of manufacture according to claim 88, wherein said computer readable program code further comprises a series of computer readable program steps to effect said activating while substantially maintaining a first temperature of the first wall and a second temperature of the second wall.

91. An article of manufacture according to claim 88, wherein said computer readable program code further comprises a series of computer readable program steps to effect:
operating said device to substantially abruptly varying the pressure from the first pressure to a second pressure; and
producing a count of second particles of a second characteristic that have become optically detectable by the optical detection system in the light as a result of said operating
wherein the second characteristic includes at least one of a geometrical size, a chemical surface property, and a shape.

92. An article of manufacture according to claim 88, wherein said computer readable program code further comprises a series of computer readable program steps to effect:
generating a representation of a spatial density of the particles as a function of a chosen characteristic thereof and/as a function of a wavelength and/or as a function of a state of polarization of said light used to illuminate said particles prior to corresponding producing a count, wherein the chosen characteristic includes at least one of a geometrical size, a chemical surface property, and a shape.

93. A method comprising:
with the use of the article of manufacture according to claim 83:
identifying first particles by exposing the first particles to a temperature gradient throughout a volume from a first wall of the two opposing walls to a second wall of the two opposing walls thereby causing condensation of the vapor of liquid on said first particles,
wherein the volume is enclosed at least in part by the shell and contains a suspension of particles and vapor of liquid in a gas;
optically counting said first particles through the optically-transparent area of the shell;
identifying second particles of a first characteristic by substantially abruptly changing a pressure in the volume from a first pressure to a second pressure thereby causing condensation of the vapor of liquid on the second particles of the first characteristic,
wherein the first characteristic includes at least one of a geometrical size, a chemical surface property, and a shape;
and
optically counting said second particles of the first characteristic through the shell area that is optically-transparent.

94. A method according to claim 93, wherein:
(a) said exposing the first particles to a temperature gradient includes changing a temperature of the first wall in comparison with a temperature of the second wall;
and/or
(b) said changing a pressure in the volume includes substantially abruptly changing a measure of the volume from a first volume value to a second volume value.

95. A method according to claim 94, wherein said exposing the first particles to a temperature gradient includes creating a temperature gradient between a top of the volume and a bottom of the volume.

96. A method according to claim 94, wherein a thermal conductivity of a material of the optically-transparent area of the shell is different from a thermal conductivity of at least one of the first and second walls.

97. A method according to claim 93, wherein said substantially abruptly changing a pressure in the volume includes varying a separation between two opposing each other portions of the shell and/or fluidly connecting an auxiliary volume to said volume.

98. A method according to claim 97,
wherein said varying the separation include repositioning a piston and/or
wherein said fluidly connecting the auxiliary volume includes moving a shutter fluidly separating the auxiliary volume from the volume.

99. A method according to claim 93, wherein said substantially abruptly changing a pressure in the volume includes increasing a size of the volume such that the second measure is larger than the first measure.

100. A method according to claim 93, wherein said identifying the second particles of the first characteristic includes maintaining a first temperature of the first wall and a second temperature of the second wall.

101. A method according to claim 93, further comprising
identifying second particles of a second characteristic by substantially abruptly changing the pressure in the volume from the second value to a third value or from the first value to the third value thereby causing condensation of the vapor of liquid on the second particles of the second characteristic,
wherein the second characteristic includes at least one of a geometrical size, a chemical surface property, and a shape,
and
optically counting said second particles of the second characteristic through the optically-transparent area of the shell.

102. A method according to claim 101, wherein at least one of the optically-counting the first particles and optically-counting the second particles of the first characteristic includes substantially simultaneously forming optical images of such particles, illuminated with an external light, with an optical detector through the optically-transparent area of the shell.
